(19) United States
(12) Patent Application Publication
(10) Pub. No.: US 2015/0228412 A1
(43) Pub. Date: Aug. 13, 2015

(54) TANTALUM CAPACITOR

(71) Applicant: SAMSUNG ELECTRO-MECHANICS CO., LTD., Suwon-Si (KR)

(72) Inventors: Hee Sung CHOI, Suwon-Si (KR); Kyoung Hwan KIM, Suwon-Si (KR)

(73) Assignee: SAMSUNG ELECTRO-MECHANICS CO., LTD., Suwon-Si (KR)

(21) Appl. No.: 14/267,157

(22) Filed: May 1, 2014

(30) Foreign Application Priority Data
Feb. 13, 2014 (KR) 10-2014-0016707

(51) Int. Cl. H01G 9/042; H01G 9/15

(52) U.S. Cl. CPC H01G 9/0425; H01G 9/15

(57) ABSTRACT

A tantalum capacitor may include: a body part having a cathode layer disposed as an outermost layer thereof; an anode wire buried in the body part with a portion thereof being led out from one surface of the body part; and a molded part enclosing the body part and the anode wire. The molded part formed on at least one surface of the cathode layer may have a thickness of 10 μm to 50 μm.

### CROSS-REFERENCE TO RELATED APPLICATION

This application claims the benefit of Korean Patent Application No. 10-2014-0016707 filed on Feb. 13, 2014, with the Korean Intellectual Property Office, the disclosure of which is incorporated herein by reference.

### BACKGROUND

The present disclosure relates to a tantalum capacitor.

Tantalum (Ta) is a material widely used throughout various industrial sectors, such as in the aerospace industry and in the defense sector, as well as in the electrical, electronic, mechanical, and chemical fields, due to mechanical and physical properties such as a high melting point, excellent flexibility, excellent corrosion-resistance, and the like.

Since tantalum can form a stable anodic oxide film, tantalum has been widely used as a material in forming anodes for small capacitors. Recently, in accordance with the rapid development of information technology (IT), information and communications technology (ICT) and electronics technology, tantalum has been increasingly used on a year-on-year basis.

Generally, a capacitor is a condenser temporarily storing electricity therein, and is a component in which two flat plate electrodes, disposed in close proximity to each other, are insulated from each other when a dielectric substance is inserted therebetween, and may be charged with an electric charge due to attractive force, thereby allowing electricity to be accumulated therein. Such a capacitor stores electric charges and electric fields in a space enclosed by two conductors, and is commonly used to acquire capacitance.

A tantalum capacitor containing a tantalum material has a structure in which voids are formed at the time of sintering and curing tantalum powder, and is completed by forming tantalum oxide (Ta₂O₅) on a tantalum surface using an anodic oxidation method, forming a manganese dioxide (MnO₂) layer, an electrolyte, on the tantalum oxide layer acting as a dielectric substance, forming a carbon layer and a metal layer on the manganese dioxide layer to form a body, forming an anode and a cathode on the body for being mounted on a circuit board, and forming a molded part.

### RELATED ART DOCUMENT

(Patent Document 1) Korean Patent Laid-Open Publication No. 2004-0011364

### SUMMARY

An aspect of the present disclosure may provide a tantalum capacitor.

According to an aspect of the present disclosure, a tantalum capacitor may include: a body part having a cathode layer disposed as an outermost layer thereof; an anode wire buried in the body part with a portion thereof being led out from one surface of the body part; and a molded part enclosing the body part and the anode wire, wherein the molded part disposed on at least one surface of the cathode layer may have a thickness of 10 μm to 50 μm.

The cathode layer may have a surface roughness of 100 nm to 500 nm.

The cathode layer may contain spherical conductive particles and flake shaped conductive particles.

The spherical conductive particles and the flake shaped conductive particles may be contained in the cathode layer at a weight ratio of 5:95 to 50:30.

The spherical conductive particles may have a particle size of 0.1 μm to 0.5 μm.

The flake shaped conductive particles may have a particle size of 3 μm to 10 μm.

The molded part may contain spherical fillers and angular fillers.

The spherical fillers and the angular fillers may be contained in the molded part at a weight ratio of 10:90 to 90:10.

The spherical fillers and the angular fillers may have an average particle size of 3 μm to 20 μm.

According to another aspect of the present disclosure, a tantalum capacitor may include: a body part having a cathode layer disposed as an outermost layer thereof; an anode wire buried in the body part with a portion thereof being led out from one surface of the body part; and a molded part enclosing the body part and the anode wire, wherein the cathode layer may have a surface roughness of 100 nm to 500 nm.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically showing a tantalum capacitor according to an exemplary embodiment of the present disclosure;

FIG. 2 is a cross-sectional view of line A-A′ of FIG. 1;

FIG. 3 is an enlarged view of portion Q of FIG. 2;

FIG. 4 is an enlarged view of portion P of FIG. 2;

FIG. 5 is a perspective view schematically showing a tantalum capacitor according to another exemplary embodiment of the present disclosure; and

FIG. 6 is a cross-sectional view taken along line B-B′ of FIG. 5.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

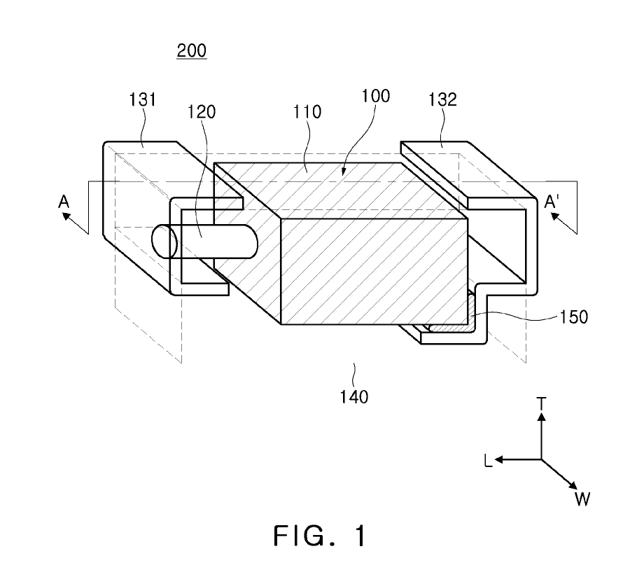

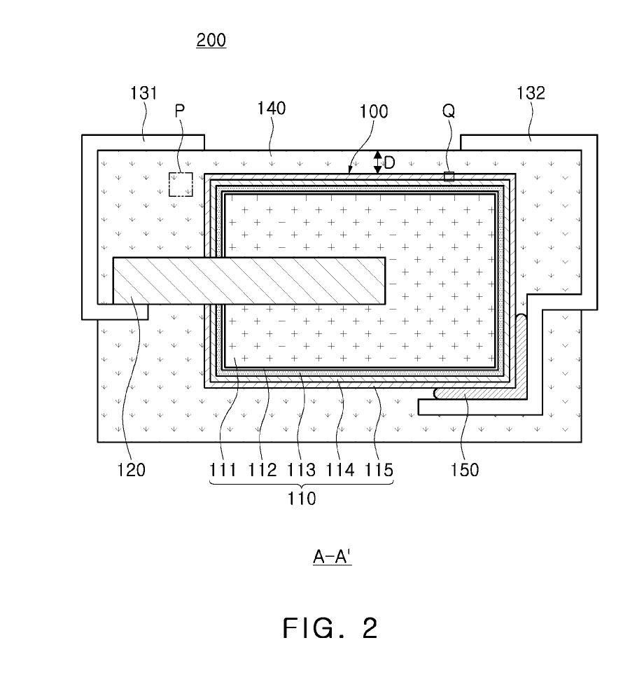

FIG. 1 is a perspective view schematically showing a tantalum capacitor according to an exemplary embodiment of the present disclosure, and FIG. 2 is a cross-sectional view taken along line A-A′ of FIG. 1.

Referring to FIGS. 1 and 2, a tantalum capacitor 200 according to an exemplary embodiment of the present disclosure may include a capacitor part 100 including a body part 110 and an anode wire 120, and a molded part 140.

According to the exemplary embodiment of the present disclosure, the body part 110 may include an anode body 111, a dielectric layer 112, a solid electrolyte layer 113, a carbon layer 114, and a cathode layer 115.

According to the exemplary embodiment of the present disclosure, the tantalum capacitor may further include lead parts 131 and 132.

Further, in this exemplary embodiment, for convenience of explanation, a direction in which the anode wire 120 is led out from the anode body 111 will be defined as a forward direction, a direction opposite to the forward direction will be defined as a backward direction, a direction parallel with the forward and backward directions will be defined as a length (L) direction, a direction perpendicular to the length direction will be defined as a thickness (T) direction, and a direction perpendicular to the length-thickness directions will be defined as a width (W) direction. In addition, one of two surfaces of the anode body 111 opposing each other in the length direction from which the anode wire 120 is led out will defined as a front surface, the other surface of the anode body 111 opposing the front surface will be defined as a rear surface, both surfaces of the anode body 111 opposing each other in the thickness direction will be defined as an upper surface and a lower surface, and both surfaces of the anode body 111 opposing each other in the width direction will be defined as side surfaces.

The anode body 111 may be formed using a tantalum material. The anode body 111 may be formed as a porous sintered body made of tantalum powder. For example, the anode body 111 may be manufactured by mixing tantalum powder and a binder at a predetermined ratio and stirring, compressing the mixture to form a rectangular parallelepiped body, and then sintering the body at a high temperature.

In addition, the anode wire 120 may be formed of tantalum and have a rod shape in which the anode wire 120 has a circular or polygonal cross-section. The anode wire may have a circular cross-section, a square cross-section, or a rectangular cross-section.

The anode body 111 may allow a portion of the anode wire 120 in the length direction to be embedded therein so that the portion of the anode wire 120 may be exposed in the forward direction.

For example, before the mixture of the tantalum powder and the binder is compressed to form the anode body 111, the anode wire 120 may be inserted into the mixture of the tantalum powder and the binder so as to be partially embedded in the center of the anode body 111.

For example, the anode body 111 may be formed by inserting the anode wire 120 into the tantalum powder mixed with the binder to form a tantalum element having a desired size and then sintering the tantalum element at about 1,000 to 2,000° C. under high vacuum atmosphere (10⁻⁵ torr or less) for about 30 minutes.

The dielectric layer 112 may be formed on a surface of the anode body 111. The dielectric layer 112 may be formed through oxidation of the surface of the anode body 111. For example, the dielectric layer 112 may be formed of a dielectric material made of tantalum oxide (Ta₂O₅), and may be formed on the surface of the anode body 111 at a predetermined thickness.

The solid electrolyte layer 113 may be formed on a surface of the dielectric layer 112 in order to form a cathode on a surface of the body part 110. The solid electrolyte layer 113 may contain at least one of a conductive polymer and manganese dioxide (MnO₂).

In the case in which the solid electrolyte layer 113 is formed of the conductive polymer, the solid electrolyte layer may be formed on the surface of the dielectric layer 112 by a chemical polymerization method or an electro-polymerization method. As the conductive polymer material, any polymer material may be used without limitation as long as it has conductivity. An example of the conductive polymer material may include polypyrrole, polythiophene, polyaniline, and the like.

In the case in which the solid electrolyte layer 113 is formed of manganese dioxide (MnO₂), conductive manganese dioxide (MnO₂) may be formed on the surface of the dielectric layer by depositing the anode body having the dielectric layer formed on the surface thereof in an aqueous manganese solution such as manganese nitrate and then pyrolyzing the aqueous manganese solution.

In order to decrease surface contact resistance, the carbon layer 114 containing carbon may be formed on the solid electrolyte layer 113.

The carbon layer 114 may be formed of a carbon paste and formed by applying the carbon paste in which a conductive carbon material powder such as natural graphite, carbon black, or the like, is dispersed in water or an organic solvent in a state in which the conductive carbon material powder is mixed with a binder, a dispersant, or the like, to the solid electrolyte layer 113.

The cathode layer 115 containing conductive particles may be disposed on the carbon layer 114 in order to improve electrical connectivity with a cathode lead, wherein the conductive particles contained in the cathode layer 115 may be silver (Ag) particles.

According to the exemplary embodiment of the present disclosure, a surface roughness of the cathode layer 115 may be 100 to 500 nm.

The surface roughness indicates a degree of fine unevenness generated on a surface at the time of processing a metal surface.

The surface roughness indicates a degree of roughness of a surface. In the case of perpendicularly cutting the surface of the cathode layer and examining the cross-section thereof, the surface of the cathode layer is curved. Here, the surface roughness maybe defined as a height difference between the lowest point of the curves and the highest point of the curves.

In the case in which the surface roughness of the cathode layer 115 is less than 100 nm, adhesion with the molded part 140 formed on the cathode layer may deteriorate, such that moisture resistance reliability and impact resistance reliability may deteriorate. In the case in which the surface roughness of the cathode layer is greater than 500 nm, flowability of a resin paste for forming a molded part may be degraded, such that a void may be formed in the resin paste. In the case in which the void is formed in the resin paste for forming a molded part, it may remain in the resultant molded part. In this case, moisture resistance reliability and impact resistance reliability may deteriorate.

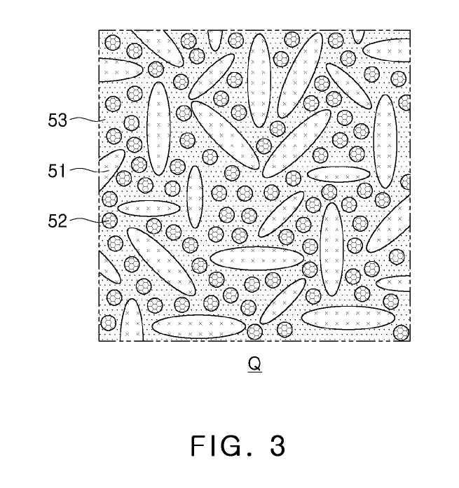

FIG. 3 is an enlarged view of portion Q of FIG. 2. Portion Q is part of the cross section of the cathode layer 115.

According to an exemplary embodiment of the present disclosure, the cathode layer 115 may contain spherical conductive particles 52 and flake shaped conductive particles 51, and may further contain organic polymers 53 for binding between the conductive particles.

The cathode layer may be formed by applying a conductive paste containing the spherical conductive particles, the flake shaped conductive particles, and the organic polymers to the carbon layer and then drying or hardening the applied conductive paste.

When a cathode layer contains all of spherical conductive particles and flake shaped conductive particles as in this exemplary embodiment of the present disclosure, flowability of a paste for forming the cathode layer and a film density of the cathode layer may be increased.

According to the exemplary embodiment of the present disclosure, a particle size of the spherical conductive particle may be 0.1 μm to 0.5 μm. In the case in which the particle size of the spherical conductive particle is less than 0.1 μm, equivalent series resistance (ESR) maybe increased due to an increase in contact resistance, and in the case in which the particles size of the spherical conductive particle is greater than 5 μm, the film density of the cathode layer may be decreased.

According to the exemplary embodiment of the present disclosure, a particle size of the flake shape conductive particle maybe 3 μm to 10 μm. In the case in which the particle size of the flake shape conductive particle is less than 3 μm, equivalent series resistance (ESR) may be increased due to an increase in contact resistance, and in the case in which the particles size of the flake shaped conductive particle is greater than 10 μm, flowability of the paste for forming the cathode layer may deteriorate.

According to the exemplary embodiment of the present disclosure, a weight ratio between the spherical conductive particles and the flake shaped conductive particles contained in the cathode layer may be 5:95 to 50:30 (spherical conductive particles:flake shaped conductive particles).

For example, the spherical conductive particles and the flake shaped conductive particles may be contained in the cathode layer at a weight ratio of 5 to 50:30 to 95 (spherical conductive particles:flake shaped conductive particles).

In the case in which the spherical conductive particles are contained in a relatively large amount to be out of such a numerical range, the equivalent series resistance (ESR) may be increased due to an increase in contact resistance, and in the case in which the spherical conductive particles are contained in a relatively small amount to be out of the numerical range, the film density of the cathode layer may be decreased.

Further, in the case in which the flake shaped conductive particles are contained in a relatively large amount to be out of the numerical range, flowability of the paste for forming the cathode layer may deteriorate, and in the case in which the flake shaped conductive particles are contained in a relatively small amount to be out of the numerical range, the equivalent series resistance (ESR) may be increased due to the increase in contact resistance.

The molded part 140 may enclose the capacitor part 100 including the body part 110 and the anode wire 120.

In order to allow the capacitor part 100 enclosed by the molded part 140 to be electrically connected to the outside, the lead parts 131 and 132 may be disposed to be connected to the capacitor part, and the lead parts may include an anode lead 131 and a cathode lead 132. The anode lead may include an anode connector and an anode terminal, and the cathode lead may include a cathode connector and a cathode terminal.

The anode connector may contact a portion of the anode wire exposed outside the anode body to thereby be electrically connected thereto, and the anode terminal may be led to the outside of the molded part to serve as a connection terminal to which a voltage is applied or another electronic product is electrically connected. The cathode connector may be electrically connected to the cathode layer, and the cathode terminal may be led to the outside of the molded part to serve as a connection terminal to which a voltage is applied or another electronic product is electrically connected.

The anode wire 120 and the anode connector may be electrically connected to each other by spot welding or laser welding or applying a conductive adhesive to thereby be electrically adhered to each other in a state in which the anode wire contacts the anode connector of the anode lead 131.

The cathode layer 115 and the cathode connector may be connected to each other by a conductive adhesive layer 150 formed of a conductive adhesive. The conductive adhesive may contain an epoxy based thermosetting resin and a conductive metal powder. The conductive adhesive layer 150 may be formed by dispensing or dotting a predetermined amount of conductive adhesive, such that the body part 110 and the cathode connector of the cathode lead 132 may be attached to each other. Then, a hardening process is performed at 150° C. to 170° C. for 40 to 60 minutes in a closed oven or under reflow hardening conditions, and the conductive adhesive layer may serve to allow the body part 110 to not move at the time of molding the resin.

In this case, the conductive metal powder may be a silver (Ag) powder, but is not limited thereto.

The anode lead and the cathode lead may be led out from both end surfaces of the molded part opposing each other, respectively, to thereby be bent toward a mounting surface of the molded part as shown in FIG. 2.

The molded part 140 may be formed by molding a resin paste to enclose the capacitor part 100.

For example, the molded part 40 may be formed by transfer molding a resin such as an epoxy molding compound (EMC), or the like.

The molded part 140 may serve to protect a solid electrolytic capacitor from the outside.

In this case, the molded part 140 may be formed to expose the anode terminal of the anode lead and the cathode terminal of the cathode lead.

For example, a temperature of a mold may be about 170° C., and the temperature for EMC molding and other conditions may be appropriately adjusted according to components and a form of the EMC.

After molding, if necessary, the hardening process may be performed at about 160° C. for 30 to 60 minutes in the closed oven or under the reflow hardening conditions.

In this case, the molding process may be performed to allow the anode terminal of the anode lead and the cathode terminal of the cathode lead to be exposed externally.

According to the exemplary embodiment of the present disclosure, a thickness D of the molded part 140 formed on the cathode layer may be 10 μm to 50 μm.

For example, the thickness of the molded part formed on at least one surface of the cathode layer may be 10 μm to 50 μm.

In the case in which the thickness of the molded part formed on at least one surface of the cathode layer is less than 10 μm, moisture resistance reliability and strength reliability may not be secured, and in the case in which the thickness of the molded part formed on at least one surface of the cathode layer is greater than 50 μm, a volume fraction of the body part in the entire tantalum capacitor may be decreased, whereby capacitance of a final product may be decreased.

However, in the case of surfaces of the molded part on which the anode lead and the cathode lead are disposed and a surface of the molded part which the anode wire is led out from as shown in FIG. 2, the thickness of the molded part formed on the cathode layer may be different from the above-mentioned numerical range due to thicknesses of the anode lead and the cathode lead or a length of the led-out portion of the anode wire.

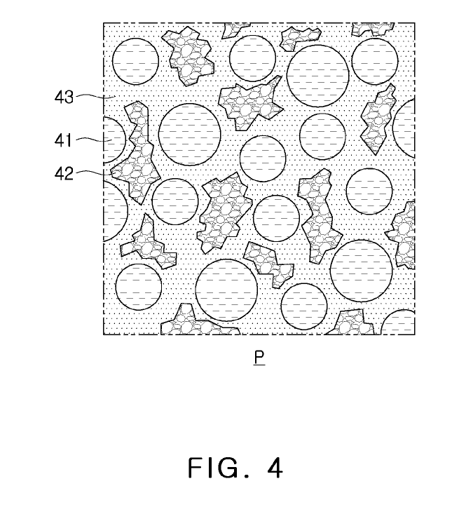

FIG. 4 is an enlarged view of portion P of FIG. 2. Portion P may be part of a cross-section of the molded part.

Referring to FIG. 4, the molded part may contain spherical fillers 41, angular fillers 42, and an epoxy resin 43.

For example, the molded part may be formed by molding the body part using an EMC containing the spherical fillers, the angular fillers, and the epoxy resin.

In the case in which a molded part contains all of spherical fillers and angular fillers as in this exemplary embodiment of the present disclosure, flowability of an EMC for forming the molded part maybe improved, and moisture resistance properties of the molded part may be excellent.

The spherical fillers and the angular fillers may contain silica.

The angular fillers may have an amorphous shape caused by crush.

According to the exemplary embodiment of the present disclosure, an average particle size of the spherical and angular fillers 41 and 42 contained in the molded part may be 3 μm to 20 μm, respectively.

In the case in which the average particle size of the spherical and angular fillers is less than 3 μm, flowability of the paste for forming the molded part may deteriorate, and in the case in which the average particle size is greater than 20 μm, a filling rate of the fillers may be decreased, whereby the moisture resistance properties may deteriorate.

For example, in the case in which the average particle size of the spherical and angular fillers is greater than 20 μm and the spherical and angular fillers contain silica, a filling rate of silica may be decreased, whereby the moisture resistance properties may deteriorate.

According to the exemplary embodiment of the present disclosure, a weight ratio between the spherical fillers and the angular fillers may be 10:90 to 90:10 (spherical fillers:angular fillers).

For example, the spherical fillers and the angular fillers may be contained in the molded part at a weight ratio of 10 to 90:90 to 10 (spherical fillers:angular fillers).

In the case in which amounts of the spherical and angular fillers are excessively large or small to be out of the above-described numerical range, a density of the fillers may be decreased, and in the case in which the spherical and angular fillers contain silica, a density of silica may be decreased.

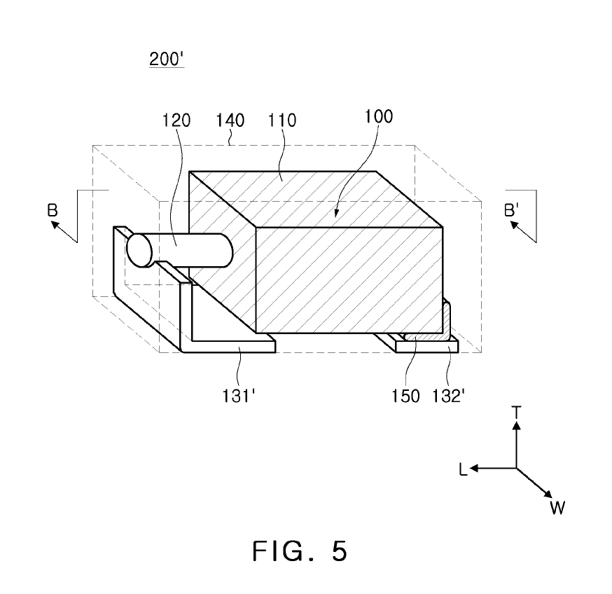

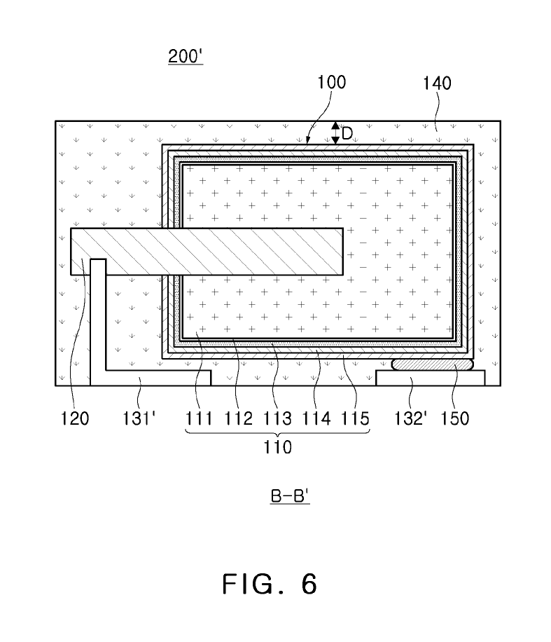

FIG. 5 is a perspective view schematically showing a tantalum capacitor 200′ according to another exemplary embodiment of the present disclosure, and FIG. 6 is a cross-sectional view taken along line B-B′ of FIG. 5. Referring to FIG. 5, in this exemplary embodiment, an anode lead 131′ and a cathode lead 132′ may be different from those illustrated in FIGS. 1 and 2.

According to this exemplary embodiment, the anode lead 131′ and the cathode lead 132′ may be led out from the same surface of the molded part. For example, one surface of an anode terminal of the anode lead 131′ may be exposed to a mounting surface of the molded part, and an anode connector connected to the anode terminal may be bent perpenticularly to the anode terminal within the molded part to thereby be connected to the anode wire 120. The anode connector may have a recess so as to make connection to the anode wire.

The cathode lead may have a flat plate shape as shown in FIG. 6, and one surface thereof may be exposed to the mounting surface of the molded part and the other surface thereof opposing to the exposed one surface may be disposed within the molded part. Although not shown, the cathode lead may have a recess for disposing the body part.

Since other elements of the capacitor according to this exemplary embodiment except for the anode lead and the cathode lead are the same as those described in the previous exemplary embodiment, a description thereof will be omitted.

Further, the anode lead and the cathode lead may have various shapes.

As set forth above, according to exemplary embodiments of the present disclosure, a tantalum capacitor having excellent moisture resistance reliability and impact resistance reliability and high capacitance efficiency may be provided.

While exemplary embodiments have been shown and described above, it will be apparent to those skilled in the art that modifications and variations could be made without departing from the spirit and scope of the present disclosure as defined by the appended claims.

What is claimed is:

1. A tantalum capacitor comprising:
a body part having a cathode layer disposed as an outermost layer thereof;
an anode wire embedded in the body part with a portion thereof being led out from one surface of the body part; and
a molded part enclosing the body part and the anode wire,
wherein the molded part disposed on at least one surface of the cathode layer has a thickness of 10 μm to 50 μm.

2. The tantalum capacitor of claim 1, wherein the cathode layer has a surface roughness of 100 nm to 500 nm.

3. The tantalum capacitor of claim 1, wherein the cathode layer contains spherical conductive particles and flake shaped conductive particles.

4. The tantalum capacitor of claim 3, wherein the spherical conductive particles and the flake shaped conductive particles are contained in the cathode layer at a weight ratio of 5:95 to 50:30.

5. The tantalum capacitor of claim 3, wherein the spherical conductive particles have a particle size of 0.1 μm to 0.5 μm.

6. The tantalum capacitor of claim 3, wherein the flake shaped conductive particles have a particle size of 3 μm to 10 μm.

7. The tantalum capacitor of claim 1, wherein the molded part contains spherical fillers and angular fillers.

8. The tantalum capacitor of claim 7, wherein the spherical fillers and the angular fillers are contained in the molded part at a weight ratio of 10:90 to 90:10.

9. The tantalum capacitor of claim 7, wherein the spherical fillers and the angular fillers have an average particle size of 3 μm to 20 μm.

10. A tantalum capacitor, comprising:
a body part having a cathode layer disposed as an outermost layer thereof;
an anode wire embedded in the body part with a portion thereof being led out from one surface of the body part; and
a molded part enclosing the body part and the anode wire,
wherein the cathode layer has a surface roughness of 100 nm to 500 nm.
